(19) United States
(12) Patent Application Publication
(10) Pub. No.: US 2005/0074667 A1
(43) Pub. Date: Apr. 7, 2005

(54) Lithium battery

(76) Inventor: Iuan-Jou Yang, Jhudong Township (TW)

Correspondence Address: BIRCH STEWART KOLASCH & BIRCH, PO BOX 747, FALLS CHURCH, VA, 22040-0747, US

(21) Appl. No.: 10/679,393

(22) Filed: Oct. 7, 2003

(51) Int. Cl. H01M 2/02; H01M 2/08; H01M 6/10

(52) U.S. Cl. 429/181; 429/94; 429/176

(57) ABSTRACT

A lithium battery includes a housing, an electrode set, and a base plate. On the housing, an electrode terminal composed of a negative terminal and a sealing ring is formed, in which a downwardly extended lead wire is attached to a depression piece inside the negative terminal. The base plate is connected with the bottom end of the housing to seal up inside space. The electrode set is arranged in the housing with its positive and negative ends attached to the bottom of the housing, in which the positive end is soldered onto the base plate while the negative end is connected with the lead wire.

### BACKGROUND OF THE INVENTION

1. Field of the Invention

The present invention relates to a lithium battery, and more particularly to a novel structure of the lithium battery, which is capable to provide a larger casing volume and accordingly a larger charge capacity to hence form a super thin (≦3.5 mm) lithium battery.

2. The Prior Arts

Lithium battery is one of the batteries widely applied in the electronic and communication products, such as mobile phones, personal digital assistants, digital cameras, notebook computers and other electronic devices. Most of the lithium battery species have a thickness greater than 3.5 mm. Some specific communication products that appeal very much to lightness, thinness, shortness, and smallness usually adopt a Li-Polymer battery, which may cost as high as 3 times of a general lithium battery.

An example of the conventional lithium battery structure is shown in FIG. 1, comprising a lid cap 1, an electrode set 2, and a casing 3. In assembling, the electrode set 2 having positive and negative elements and a separating film interfaced between the elements is laid in the casing 3. A negative terminal 21 and a positive terminal 22 are spot-welded to a depression piece and the lid cap 1 respectively. Finally, the lid cap 1 is mounted and sealed on the casing 3 to thereby form a lithium battery.

As illustrated in FIGS. 2A and 2B, the lid cap 1 of the conventional lithium battery comprises a lid body 1′, a negative end 11, and a sealing ring 12. The negative end 11 extends into the interior space of the battery to form a depression piece 13 and has a negative terminal 21 soldered thereon. When making a super thin lithium battery (≦3.5 mm), since the sealing ring 12 is situated too close to a circumferential welding channel 14 of the casing 3, the sealing ring 12 is probably deformed by the high welding temperature to therefore result in a leakage of liquid. This is the reason why a lithium battery thinner than 3.5 mm is not available in the market.

### SUMMARY OF THE INVENTION

A primary object of the present invention is to provide a super thin structure of lithium battery formed by moving the welding and sealing position of battery housing to a farther location with respect to the position of the negative end and the sealing ring such that the thickness of battery is cut down and as short as 3.5 mm.

In order to realize above object, the lithium battery of the present invention comprises a housing, an electrode set, and a base plate. An electrode terminal composed of a negative end and a sealing ring is arranged on the housing. A depression piece of the negative end has a downwardly dependent lead wire. The base plate is combined to the bottom end of the housing for sealing the interior space. The electrode set is disposed in the housing and its positive and negative ends are located at the bottom of the housing. The positive end is soldered onto the base plate while the negative end is connected to the lead wire to thereby form the lithium battery.

The merits of the present invention may be summarized as the following:
(1) The thickness of the lithium battery is equal to or thinner than 3.5 mm.
(2) The cost is saved up to two-third of the conventional lithium battery.
(3) A space of 1-2 mm more than the conventional lithium battery can be obtained with the present invention.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is an exploded view of a conventional lithium battery;

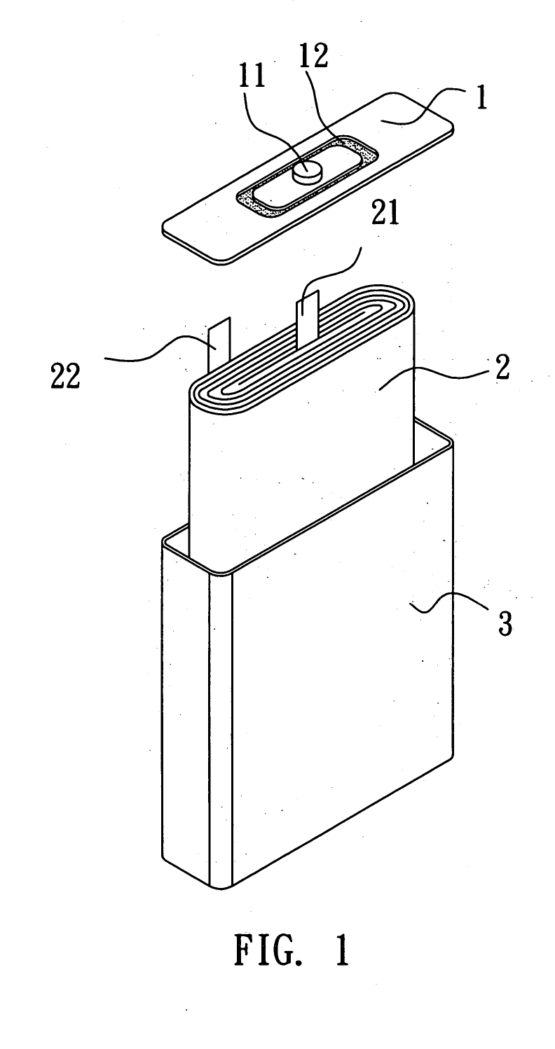

FIGS. 2A and 2B are cross-sectional views of the conventional lithium battery;

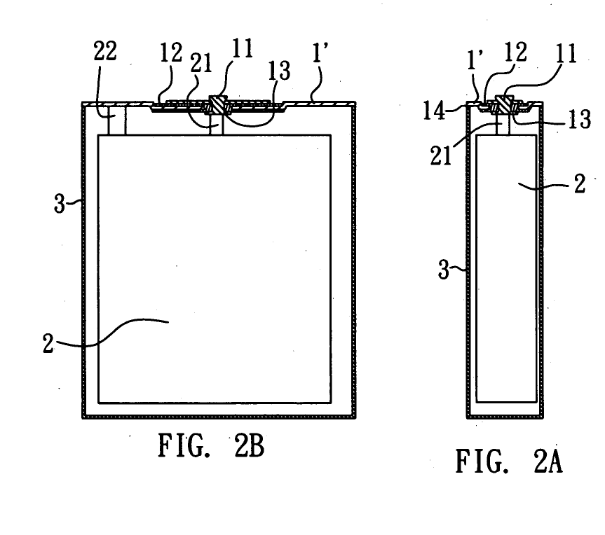

FIG. 3 is an exploded view of a lithium battery in accordance with the present invention;

FIG. 4 is a cross-sectional view of a housing of the lithium battery in accordance with the present invention; and

FIG. 5 is a cross-sectional view of the lithium battery in accordance with the present invention.

### DETAILED DESCRIPTION OF THE PREFERRED EMBODIMENT

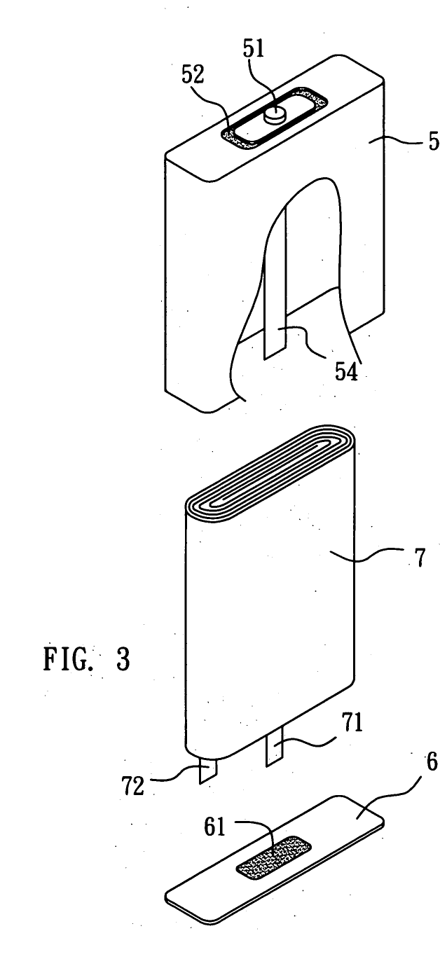

With reference to the drawings and in particular to FIG. 3, a lithium battery constructed in accordance with the present invention comprises a housing 5, a base plate 6, and an electrode set 7.

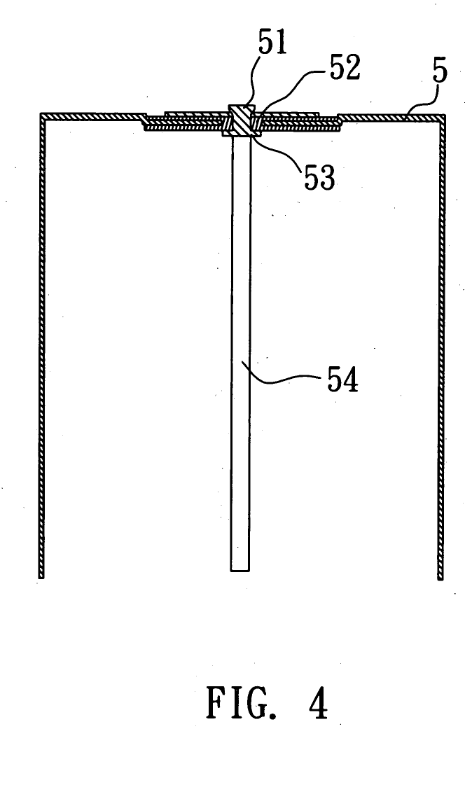

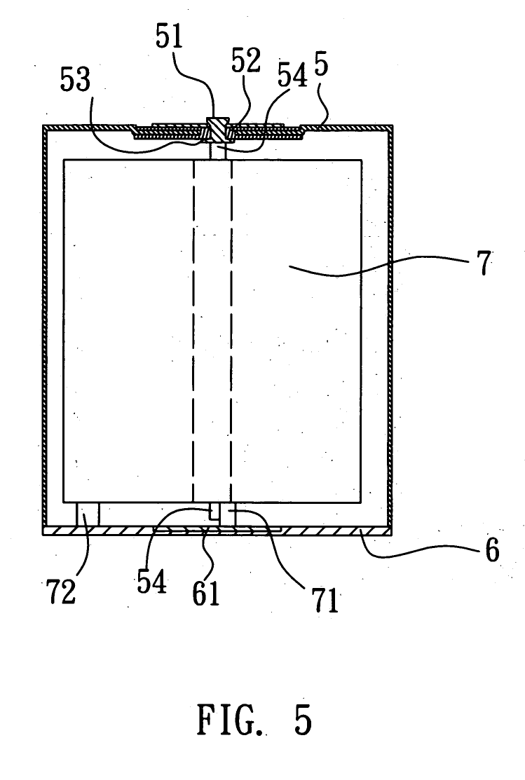

The housing 5 is substantially a rectangular box, made of nickel-plated steel, aluminum, or stainless steel, having a closure-like end (top end), in which a through hole is formed in the top end, where is also an electrode terminal comprised of a negative terminal 51 and a sealing ring 52. Also referring to FIGS. 4 and 5, the negative terminal 51 is extended to inside of the housing 5 to form a depression piece 53, on which a lead wire 54 is arranged and extended downwardly to connect with a negative end 71 of the electrode set 7. The sealing ring 52 is located between the negative terminal 51 and the housing 5 and sealed for prevention of short circuit or leakage of electrolyte.

The base plate 6 is a metallic piece shaped to mate with an open end of the housing 5 and to be welded at the bottom end of the housing 5, when assembling. Also, on the central portion of the base plate 6, an insulation material coated insulating section 61 is provided. The electrode set 7 is a jelly roll comprised of a positive and a negative device as well as a separation film interfaced therebetween, and is disposed in a sealed space constructed by the housing 5 and the base plate 6. In the assembling process, both a positive end 72 and the negative end 71 are situated at the bottom end of the housing 5, in which th e positive end 72 is welded onto the base plate 6, while the negative end 71 is connected to the lead wire 54 of the housing 5, which is extended downwardly to depend through a winding space of the electrode set 7.

The lithium battery of the present invention is assembled by starting with mounting the negative terminal 51 and the sealing ring 52 on the housing 5 and then combining the lead wire 54 with the depression piece 53 of the negative terminal 51, placing the electrode set 7 in the housing 5, where the lead wire 54 is extended downwardly through the winding space of the electrode set 7 and connected with the negative end 71 and the surplus part of the lead wire 54 is dependent on the insulating section 61 of the base plate 6; welding the positive end 72 onto the base plate 6; and finally, disposing the base plate 6 under the housing 5 for sealing up. Since the position for sealing up is far away from the sealing ring of the housing 5, the defects in the conventional structure could be thoroughly eliminated to make the fabrication of a lithium battery thinner than 3.5 mm possible.

The shape of the lithium battery of the present invention is not restricted to rectangular and it could be either square or elliptical for example.

In the above described, at least one preferred embodiment has been described in detail with reference to the drawings annexed, and it is apparent that numerous changes or modifications may be made without departing from the true spirit and scope thereof, as set forth in the claims below.

1. A lithium battery, comprising:
a housing, which is substantially a metallic receptacle box provided with a closure-like end, on which an electrode terminal composed of a negative terminal and a sealing ring is formed, in which the negative terminal is extended to inside of the housing to form a depression piece, which combines with a downwardly extended lead wire;
a base plate, which is combined with a bottom of the housing and provided with an insulating section inside; and
an electrode set, which is a jelly roll comprised of a positive and a negative device as well as a separation film interfaced therebetween and disposed in a sealed space constructed by the housing and base plate, in which a positive end is connected with the base plate while a negative end is connected with the lead wire.

2. The lithium battery according to claim 1, wherein the housing is square

3. The lithium battery according to claim 1, wherein the housing is rectangular

4. The lithium battery according to claim 1, wherein the housing is elliptical.
